(19) United States
(12) Patent Application Publication
(10) Pub. No.: US 2011/0219357 A1
(43) Pub. Date: Sep. 8, 2011

(54) COMPRESSING SOURCE CODE WRITTEN IN A SCRIPTING LANGUAGE

(75) Inventors: Benjamin Livshits, Kirkland, WA (US); Benjamin Goth Zorn, Woodinville, WA (US); Martin Burtscher, Austin, TX (US); Gaurav Sinha, Noida (IN)

(73) Assignee: Microsoft Corporation, Redmond, WA (US)

(21) Appl. No.: 12/715,405

(22) Filed: Mar. 2, 2010

(51) Int. Cl. G06F 9/44

(52) U.S. Cl. 717/115

(57) ABSTRACT

A method described herein includes at a computing device, receiving, over a network connection, a data packet from an external source, wherein the data packet comprises a compressed abstract syntax tree (AST)-based representation of source code written in a scripting language. The method further includes decompressing the compressed AST-based representation of the source code to generate a decompressed AST. The method also includes causing at least one processor on the computing device to execute at least one instruction represented in the decompressed AST subsequent to the compressed AST-based representation of the source code being decompressed.

### BACKGROUND

Conventional Internet browsing applications (browsers) are configured to allow a user thereof to access information available on the Internet. Additionally, conventional browsers can be configured to access and utilize applications that are available by way of the Internet (web applications). In traditional web applications, execution of code pertaining to a browser window occurs entirely on the server side, such that every update made by an individual in a browser executing on a client computing device triggers a round-trip message to the server, followed by a refresh of the browser window in its entirety (a download of data to the browser that allows the browser to refresh the browsing window). This round-trip messaging and downloading of data to the client can take a significant amount of time, particularly when relatively complex web applications are utilized, such as email applications, mapping applications, etc., and also particularly when a significant amount of data is desirably transmitted to the client computing device.

Over the last several years, more sophisticated distributed web applications have been generated and made available to users. These more sophisticated applications are enabled based at least in part upon the ability of the browser to execute client-side code, such as JavaScript®, to provide a smooth, highly responsive, user experience while a rendered web page is dynamically updated in response to user actions and client server interactions. As the sophistication and feature sets of such web applications continues to grow, however, downloading code for execution on the client is increasingly becoming a bottleneck in both initial startup time and subsequent application reaction time. For example, some sophisticated web applications are configured to transmit over one megabyte of uncompressed source code from a server to a client, wherein the code is desirably executed by an application running on the client. Clearly, requiring a user to wait until an entire portion of code corresponding to a sophisticated web application has been transmitted to the client before execution thereof does not result in a very responsive user experience, particularly on low bandwidth connections.

One mechanism utilized to reduce such bottlenecks is to compress executable code desirably transmitted from a server to a client. For example, some tools are utilized to “minify” source code by removing superfluous white space in the source code (tabs, spaces, etc.). Other forms of minification can also be employed. Subsequent to the code being minified, such code can be compressed with a compression scheme such as gzip. The compressed source code is then transmitted to the client, where an application executing on the client decompresses the compressed source code and parses such code to prepare the code for execution on the client computing device.

### SUMMARY

The following is a brief summary of subject matter that is described in greater detail herein. This summary is not intended to be limiting as to the scope of the claims.

Various technologies pertaining to generating an Abstract Syntax Tree (AST)-based representation of source code written in a scripting language, compressing such AST-based representation of the source code, transmitting the compressed AST-based representation of the source code to a client computing device over a network, and decompressing the compressed AST-based representation of the source code at the client computing device are described in detail herein. Source code written in a scripting language that conforms to the ECMAscript standard, such as JavaScript® may be desirably transferred from a first computing device, such as a server, router, etc., to a second computing device, such as a client computing device by way of a network connection, such that the second computing device can execute an instruction in the source code. As described in greater detail herein, the source code can be parsed into an AST-based representation of such source code, and thereafter compressed at the first computing device. This compressed AST-based representation may then be transmitted over a network connection to the second computing device, wherein the second computing device can be configured to decompress the AST-based representation and generate an AST that corresponds to the original source code. The second computing device may then be configured to execute at least one instruction included in the AST. Since the code received at the second computing device is in AST-based format, the second computing device need not parse such code. Rather, the second computing device can directly interpret the AST or convert the AST to executable code and thereafter execute such code.

In one aspect described in greater detail herein, the first computing device can parse the source code into a plurality of different streams of data. This plurality of different streams of data can comprise a stream of productions, which represents grammar rules of the scripting language utilized to generate the source code; a stream of identifiers, which represents variables in the source code; and a stream of literals, which represents constants and strings in the source code. The stream of productions can be compressed in an AST-based format through, for example, a compression technique based at least in part upon prediction by partial match (PPM) techniques. The stream of identifiers may be compressed through utilization of local and global symbol tables with offsets pointing to particular global symbols or symbols in certain scopes. Additionally, the stream of identifiers can be compressed by sorting identifiers in a symbol table based at least in part upon frequency of use of the identifiers in the source code. Further, the stream of identifiers can be compressed through utilization of a built-in symbol table, through utilization of variable length encoding, and through utilization of renaming of identifiers in local symbol tables. The stream of literals can be compressed, for example, through utilization of symbol tables, grouping literals by types, eliminating known prefixes and postfixes, or through any other suitable technique. Pursuant to an example, these three compressed streams can be placed in a data packet and transmitted to the second computing device. For instance, the second computing device may comprise a browser that is executing on such device, and the browser can be configured with executable code that is utilized to decompress the three separate streams to generate an AST that corresponds to the source code. Such AST may then be executed by the second computing device.

Pursuant to another aspect described herein, prior to transmitting the three compressed streams, such streams can be further compressed utilizing a compression model such as gzip. Thus, the source code on the first computing device can be compressed through utilization of a multi-stage compression system, and the second computing device can be configured with a multi-stage decompression system.

Other aspects will be appreciated upon reading and understanding the attached figures and description.

### BRIEF DESCRIPTION OF THE DRAWINGS

FIG. 1 is a functional block diagram of an example system that facilitates transmitting a compressed AST-based representation of source code.

FIG. 2 depicts an example parsing of source code in a scripting language to a plurality of different streams.

FIG. 3 represents compressing an identifier stream through utilization of global and local symbol tables.

FIG. 4 is a functional block diagram of an example system that facilitates receiving and decompressing a compressed AST-based representation of source code written in a scripting language.

FIG. 5 is a flow diagram illustrating an example methodology for compressing an AST-based representation of source code written in a scripting language.

FIG. 6 is a flow diagram illustrating an example methodology for utilizing a multi-stage compression system to compress an AST-based representation of source code written in a scripting language.

FIG. 7 is a flow diagram illustrating an example methodology for decompressing an AST-based representation of source code written in a scripting language.

FIG. 8 is a flow diagram illustrating an example methodology for utilizing a multi-stage decompression system to decompress an AST-based representation of source code written in a scripting language.

FIG. 9 is an example computing system.

### DETAILED DESCRIPTION

Various technologies pertaining to the transmittal of a compressed Abstract Syntax Tree (AST)-based representation of source code written in a scripting language will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

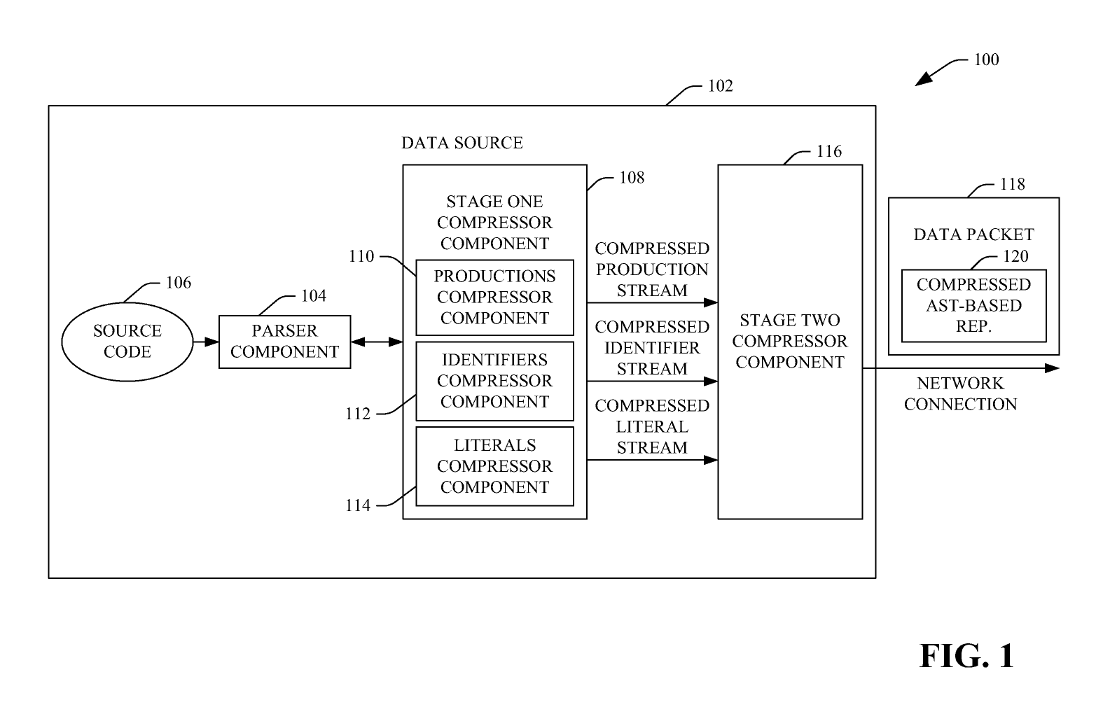

With reference to FIG. 1, an example system 100 that facilitates compressing an AST-based representation of source code written in a scripting language is illustrated. The system 100 comprises a data source 102, which may be any suitable computing device that can communicate with another computing device by way of a network connection. For example, the data source 102 may be a server such as a web server, an application server, or other suitable server. In another example, the data source 102 may be a network device such as a router, a bridge, etc. In still yet another example, the data source 102 may be a client computing device participating in a peer-to-peer application (such that the client computing device acts as a server with respect to another client computing device). Thus, the data source 102 may be any suitable computing device that can be configured to perform the compression of source code as described herein.

The data source 102 comprises a parser component 104 that receives source code 106 written in a scripting language, such as a scripting language that corresponds to the ECMAscript standard (e.g., JavaScript®), Perl, VBscript, XUL, or some other suitable scripting language As used herein, the term “scripting language” is intended to encompass programming languages that can be utilized to extend the functionality of certain software by being implemented with a virtual machine running within that software and allowing code written in the scripting language to control aspects of such software. Examples of specific aspects that can be controlled include the graphical user interface, doing computation, and communicating via network connections. For example, scripting languages are particularly relevant in modern computer systems as they allow entire applications to be delivered via a network to execute in the context of a web browser. The parser component 104 can be configured to parse the source code 106 into an AST-based representation of such source code 106. As will be readily understood, an AST is a computer-implemented tree representation of abstract syntactic structure of source code written in a particular programming language. For purposes of explanation but not limitation, an example is provided herein of the parser component 104 parsing JavaScript® code to generate an AST-based representation of the source code 106.

JavaScript® code is expressed as a sequence of characters that has to follow a specific structure to represent a valid program. This character sequence can be broken into subsequences called tokens, which comprise keywords, predefined symbols, white space, user-provided constants, and user-provided names. Keywords include strings such as “while” and “if”. Symbols include operators such as − and ++, as well as semicolons, parentheses, etc. White space typically comprises nonprintable characters, and most commonly refers to one or more blank spaces or tab characters. User-provided constants include hard-coded string, integer, and floating point values. User-provided identifiers comprise variable names, function names, etc.

The order in which the aforementioned tokens are allowed to appear to be a valid program is defined by JavaScript® grammar which specifies syntax rules. For example, one such rule is that the keyword “while” must be followed by an opening parenthesis that is optionally preceded by white space. Such syntax forces valid programs to conform to a strict structure. In other words, randomly generated text files will rarely ever represent a proper JavaScript® program.

The parser component 104 can expose the structure of a JavaScript® program (or program written in some other scripting language), by breaking down the source code 106 into an AST-based representation, such that nodes of the AST-based representation comprise the tokens mentioned above. An AST that can be generated from the AST-based representation specifies the order in which the grammar rules have to be applied to obtain the program at hand. Such rules are referred to herein as productions, constants are referred to herein as literals, and variable and function names are referred to herein as identifiers. The parser component 104 can extract and separate the productions, identifiers, and literals that represent the source code 106.

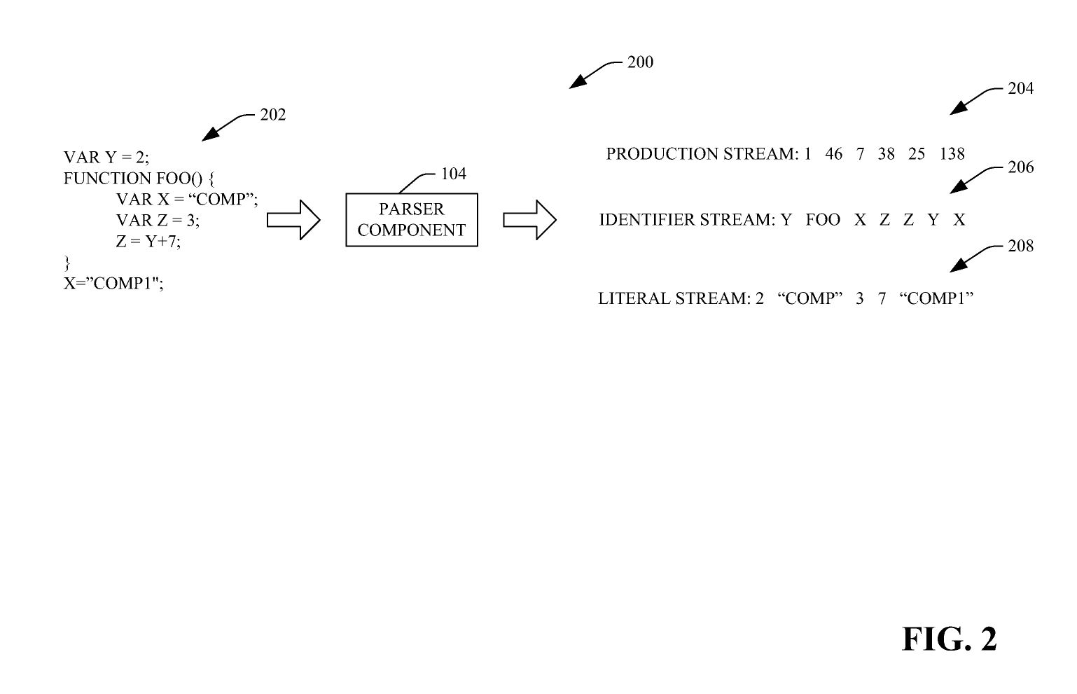

Referring briefly to FIG. 2, a parsing 200 of an example JavaScript® function into a production stream, an identifier stream, and a literal stream is illustrated. An example function 202 that corresponds to a scripting language that has a plurality of rules (e.g., 236) that specify grammar rules associated therewith is as follows:

```
var y=2;
function foo ( ){
  var x = “Comp”;
  var z = 3;
  z=y+7;
}
x=“Comp1”;
```

In this example, a production stream 204 corresponding to the function 202 is shown in linearized format and comprises identifiers of rules corresponding to the numbers (in an example) 1, 46, 7, 38, 25, and 138.

Additionally, the parser component 104 can generate an identifier stream that comprises identifiers in the function 202. In an example, the parser component 104 can generate an identifier stream 206 such that the identifier stream includes identifiers in an order that identifiers are encountered in the function 202. Thus, in this example, the identifier stream 206 comprises the identifiers Y, FOO, X, Z, Z, Y, X.

The parser component 104 can also generate a literal stream 208 based at least in part upon the example function 202, wherein the literal stream 208 comprises a sequence of literals in an order that the literals are encountered by the parser component 104. In the example shown in FIG. 2, the literal stream 208 comprises the literals 2, “COMP”, 3, 7, and “COMP1”.

Returning to FIG. 1, a stage one compressor component 108 can receive streams output by the parser component 104, and can be configured to individually compress each of the streams separately. While the parser component 104 has been described as outputting streams of productions, identifiers and literals, it is to be understood that the parser component 104 may be configured to output other types of streams, including but not limited to streams that include comments.

As previously mentioned, the stage one compressor component 108 can be configured to individually compress different streams output by the parser component 104. For example, the stage one compressor component 108 can comprise a productions compressor component 110 that is configured to receive productions output by the parser component 104 and compress such productions. The productions shown in the productions stream 204 of FIG. 2 are shown to be in linear form. Pursuant to an example, the productions compressor component 110 may be configured to compress such a linear stream of productions. For instance, the productions compressor component 110 can be configured to rename productions with integers. For example, the production program=>SourceElements can be represented by the integer 225, and such production can be renamed to the integer 1 if it was a common production in the production stream. Therefore, the productions compressor component 110 can be configured to minimize the frequency of large production IDs, while maximizing the frequency of small production IDs.

Furthermore, the productions compressor component 110 may be configured to receive a linear stream of productions output by the parser component 104 and perform differential encoding on such productions. Differential encoding works based on the observation that only a few productions can follow a certain given production. Therefore, particular productions can be renamed based upon such observation.

In still yet another example, the productions compressor component 110 can receive a linear stream of productions output by the parser component 104, and compress such stream of productions through utilization of a chain rule. A chain rule indicates that some productions always follow one particular production. For such chain of productions, the productions compressor component 110 can only record the first production (e.g., remove subsequent productions from the stream output by the parser component 104).

In an alternative embodiment, the parser component 104 can be configured to output the production stream in the form of an AST-based representation, rather than a linear stream. In such a case, the productions compressor component 110 can be configured to compress the AST-based representation output by the parser component 104. In an example, depending upon a language utilized to write the source code 106, productions may be more compressible when configured in a tree format. For instance, an example production can have two symbols on the right hand side (e.g., an “if” statement with a “then” and an “else” block). Such a production typically corresponds to a node and two children in an AST-based representation, regardless of the context in which the production occurs. In a linearized form, a first child appears directly subsequent to the parent, but the second child appears at an arbitrary distance from the parent, wherein such arbitrary distance depends upon the size of a subtree under the first child (the size of the “then” block in this example). This can render it difficult for a data model to anticipate symbols, and therefore renders it difficult for a data model to achieve adequate compression.

The productions compressor component 110 can be configured to mitigate this problem, as the children of a node can always be encoded in the context of the parent, making it easier to predict and compress the productions. An additional piece of information that can be utilized for compression is the position of the child, since each child of a node has the same parent, grandparent, etc. In other words, the productions compressor component 110 can use the path from a root node to a node and information about which child the node represents as context for compressing such node.

In a particular example, the productions compressor component 110 can utilize any suitable context-based data compression technique, such as prediction by partial match or a variant thereof. Prediction by partial match (PPM) operates by recording, for each encountered context, what symbol follows such context, so that the next time the same context is seen, a lookup can be performed to provide the likely next symbols together with their probability of occurring. A maximum allowed context length can determine size of the lookup table. In an example, the productions compressor component 110 can utilize a context length of 1 (just using the parent as well as the empty context) to perform prediction by partial match. Since, however, the lookup table may produce a different prediction for a O-order context and a first-order context, the productions compressor component 110 can utilize a special algorithm to specify what to do in such case.

For example, the productions compressor component 110 can be configured to utilize a scheme that incorporates portions of PPMA and PPMC. Specifically, the productions compressor component 110 can be configured to pick a longest context that has occurred at least once before, and defaulting to an empty context if no context has previously occurred. For instance, if tree nodes can have up to four children, the productions compressor component 110 can utilize four distinct PPM tables, one for each position (one for each child). For each context, the tables record how often each symbol follows. PPM can then be utilized to predict the next symbol with a probability that is proportioned to its frequency, and the productions compressor component 110 can utilize an arithmetic coder to compactly encode the proper symbol.

To ensure that each context can make a prediction, the productions compressor component 110 can configure the first order context to indicate that the current production has not been seen before, and that the empty context should be queried. In an example, the frequency of the “escape” symbol can be set at 1. The productions compressor component 110 can prime an empty context with each possible production, which is to say that each possible production is initialized with a frequency of 1. Accordingly, an escape symbol may not be necessary.

Unlike in conventional PPM implementations, where an order −1 context is used for this purpose, the productions compressor component 110 can use the order 0 context, as it tends to encounter most productions relatively quickly. To add aging, which gives more weight to recently seen productions, the productions compressor component 110 can scale down frequency counts by a factor of 2 whenever one of the counts reaches a predefined maximum. In an example, the predefined maximum can be 127. The productions compressor component 110 can further employ update exclusion, meaning that the empty context is not updated if the first order context was able to predict the current production. Further, the productions compressor component 110 need not encode an end-of-file symbol or record the length of the file, because decompression automatically terminates when the tree is complete.

The Stage One compressor component 108 can further include an identifiers compressor component 112 that is configured to compress the stream of identifiers output by the parser component 104 pertaining to the source code 106. As will be described in greater detail below, the identifiers compressor component 112 can generate a global symbol table, one or more local symbol tables, can utilize built-ins to represent symbols, and can sort symbols by frequency, and can further utilize variable length encoding to encode symbols to compress the stream of identifiers output by the parser component 104. Pursuant to an example, the identifiers compressor component 112 can receive the stream of identifiers output by the parser component 104 and can generate at least one symbol table, wherein the at least one symbol table includes each unique identifier that exists in the stream of identifiers, and indices corresponding thereto. Therefore, the identifiers compressor component 112 can record each unique identifier in the symbol table and replace the stream of identifiers by indices into this table. The identifiers compressor component 112 may then optionally split the symbol table into a global scope table and one or more local scope tables. Only one local scope table may be active at a time, and function boundary information, which can be derived from production in the productions stream, can be used to determine when to switch local scope tables. Thus, a relatively small number of indices can be utilized to specify identifiers in the identifier stream.

Furthermore, the identifiers compressor component 112 can sort symbols in the symbol tables by frequency, thereby making small offsets more frequent. Specifically, because not all identifiers appear equally often, the identifiers compressor component 112 can sort each symbol table from most to least frequently used identifier. Accordingly, a resulting compressed stream of identifiers will include mostly small values, which makes the identifier stream more compressible when using variable length encoding, which can also be undertaken by the identifiers compressor component 112.

Moreover, the identifiers compressor component 112 can rename local variables. This is because during decompression and execution, names of variables in local scopes are not needed to be reproduced. The identifiers compressor component 112 can rename local variables arbitrarily, as long as uniqueness remains and there are no clashes with keywords or global identifiers. Thus local variables can be given very short names, such as “a”, “b”, “c”, etc. Furthermore, the identifiers compressor component 112 can utilize a built-in table of common variable names to eliminate the requirement to store such names explicitly. Accordingly, many local scopes become empty, and the index stream alone suffices to specify which identifier is used (essentially, the index is the variable name). It is to be noted that the identifiers compressor component 112, in some examples, does not apply renaming to global identifiers such as function names, because external code may call such functions, wherein calling such functions is done by name.

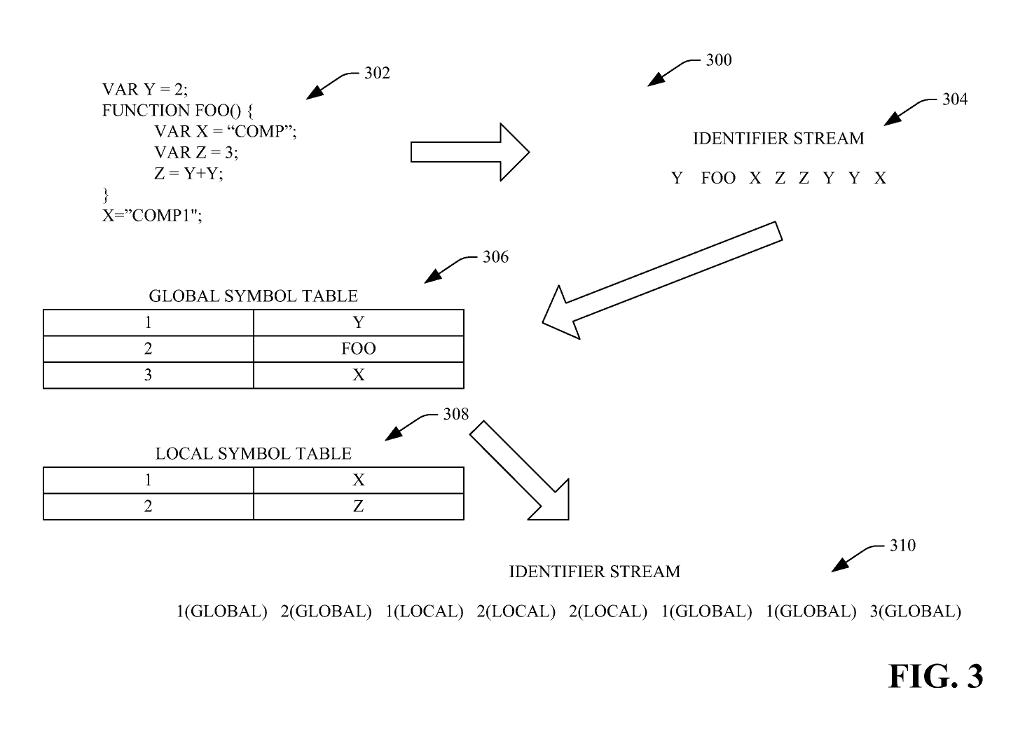

Turning briefly to FIG. 3, an example placement of identifiers 300 pertaining to a function in global and local symbol tables is illustrated. This example pertains to the following function:

```
var y=2;
function foo ( ){
  var x = “comp”;
  var z = 3;
  z = y + y;
}
x=“comp1”;
```

The parser component 104 can parse the function 302 into an identifier stream 304, wherein the identifier stream 304 includes the identifiers y, foo, x, z, z, y, y, x. A global symbol table 306 will include a list of global identifiers (y, foo, and x), that correspond to indices (indices 1, 2 and 3). As indicated previously, the identifiers compressor component 112 can sort the symbols in the global symbol table 306 by frequency of occurrence. Additionally, identifiers in a scope of the function 302 can include the identifiers x and z, which can be placed in a local symbol table 308. As shown in the local symbol table 308, the identifiers x and z can correspond to indices 1 and 2.

Accordingly, the identifier stream 304 can be replaced with a more compressed identifier stream, which can include a value of an index corresponding to identifiers in the identifier stream, and a value indicating to which table the identifiers belong. For example, headers can be utilized to indicate identifiers that belong to the global symbol table 306 and identifiers that belong to the local table 308. Therefore, the identifiers compressor component 112 can output an identifier stream 310 that includes indices of the global and local symbol tables 306 and 308, respectively, and values indicating that the indices belong to a certain global or local symbol table. The updated identifier stream thus can be represented as follows: 1(global) 2(global) 1(local) 2(local) 2(local) 1(global) 1(global) 3(global).

Returning again to FIG. 1, the stage one compressor component 108 may further comprise a literals compressors component 114 that is configured to compress the literal stream output by the parser component 104. Pursuant to an example, the literals compressor component 114 may be configured to generate symbol tables for literals in the source code 106 similar to a manner in which the identifiers compressor component 112 is configured to generate symbol tables for identifiers in the identifier stream output by the parser component 104.

In another example, the literals compressor component 112 can be configured to group literals in the literal stream output by the parser component 104 by type. In an example, the literal compressor component 112 can determine type of literals by analyzing the production stream output by the parser component 104. Thus, in an example, the literals compressor component 112 can be configured to separate string and numeric literals. Additionally, for instance, the literals compressor component 112 can be configured to separate numeric literals into floating point and integer literals.

In still yet another example, the literals compressor component 112 can be configured to eliminate known prefixes and postfixes in literals in the literal stream output by the parser component 104. Thus, in an example, the literals compressor component 112 can be configured to remove quotation marks surrounding strings, and use a single character separator to delineate literals, instead of a new line/carriage return pair. After the productions compressor component 110, the identifiers compressor component 112, and the literals compressor component 114 have compressed the stream of productions, the stream of identifiers, and the stream of literals, respectively, output by the parser component 104, the stage one compressor component 108 can be configured to output an AST-based representation of the productions, the compressed stream of identifiers, and the compressed stream of literals.

A stage two compressor component 116 can receive a subset of the compressed AST-based representations of the productions, the compressed stream of identifiers, and the compressed stream of literals, and can further compress such subset. For example, the stage two compressor component 116 can be configured to only receive the compressed stream of identifiers and the compressed stream of literals, as the AST-based representation of the source code output by the productions compressor component 110 may not be further compressible by the stage two compressor component 116. For instance, the stage two compressor component 116 may be any suitable compression model, such as gzip. This can allow the AST-based representation of the source code 106 (the compressed tree-based representation of the productions, the stream of identifiers, and the stream of literals) to be placed in a file suitable for transmission over a network connection. Thus, the stage two compressor component 116 may be configured to output a data packet 118, wherein the data packet 118 includes a compressed AST-based representation 120 of the source code 106. The data packet 118 may be transmitted to a client computing device, for instance, by way of any suitable network connection.

While FIG. 1 displays a two-stage compression system, it is to be understood that the claims are intended to encompass any suitable multi-stage compression and decompression system (e.g., where three or more stages are included in such system), wherein the two stages described herein may be portions of a multi-stage system.

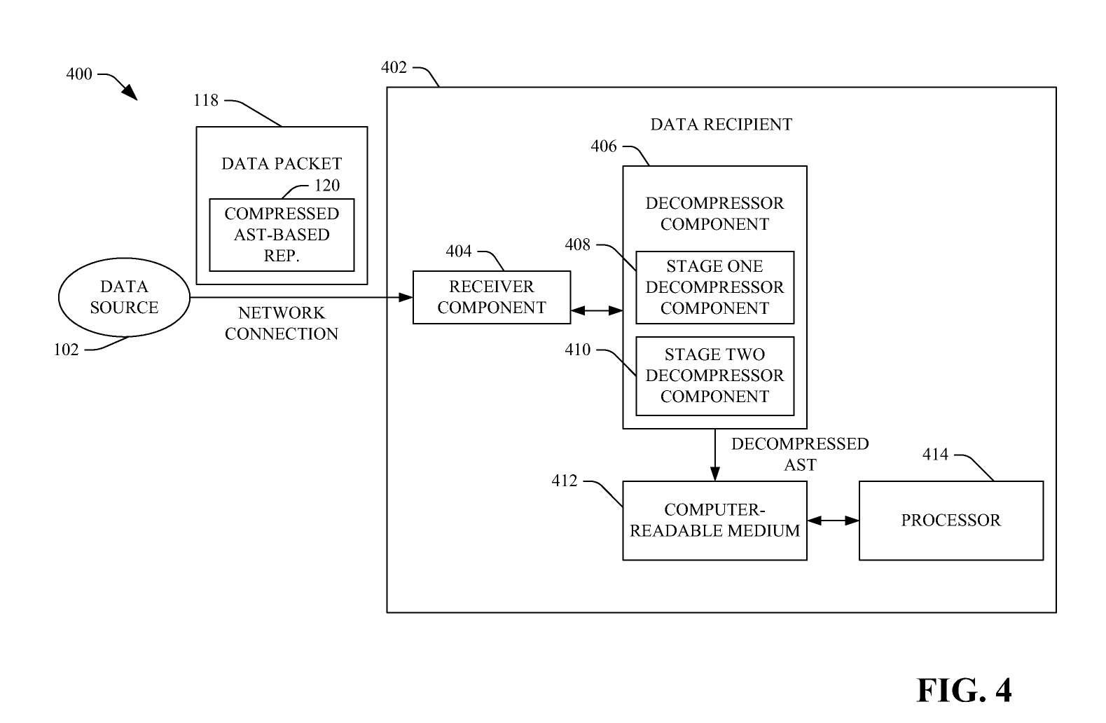

Now turning to FIG. 4, an example system 400 that facilitates decompression and execution of instructions pertaining to a compressed AST-based representation of source code is illustrated. The system 400 comprises a data recipient 402 that desirably receives the compressed AST-based representation of the source code and executes at least one instruction represented by the compressed AST-based representation of the source code. The data recipient 402 may be any suitable computing device that can receive data by way of a network connection. Thus, the data recipient 402 may be a personal computer, a laptop computer, a mobile telephone, or some other mobile computing device. Pursuant to an example, the data recipient 402 may have a browser executing thereon, wherein the browser is configured to execute code written in a scripting language such as JavaScript®.

The data recipient 402 comprises a receiver component 404 that is configured to receive the data packet 118 transmitted by the data source 102, wherein the data packet 118 comprises the compressed AST-based representation 120 of the source code written in the scripting language.

A decompressor component 406 can be in communication with the receiver component 404, and can receive the data packet 118. The decompressor component 406 comprises a stage one decompressor component 408 that decompresses the compression undertaken by the stage two compressor component 116 (FIG. 1). Thus, in an example, the stage one decompressor component 408 may be configured to decompress files that are compressed by way of gzip.

The decompressor component 406 may further include a stage two decompressor component 410 that is configured to further decompress the AST-based representation of the source code to generate an AST that represents the source code. The stage two decompressor component 410 can correspond with the stage one compressor component 108 (FIG. 1). Thus, the stage two decompressor component 410 may generate a tree-based representation of the production stream and can assign identifiers and literals to nodes of the tree. The decompressor component 406 may then cause the resulting, decompressed AST to be placed in a computer readable medium 412 residing on the data recipient 402. For instance, the computer readable medium 412 can be memory, such as RAM, Flash memory, etc. A processor 414 can have access to the computer readable medium 412, and can execute at least one instruction represented in the AST that is stored in the computer readable medium 412.

Prior to the decompressed AST being stored in a computer readable medium 412, one or more analyses can be undertaken with respect to the AST. For example, the AST can be analyzed to ensure that source code corresponding to the AST is well formed, and the AST has not been subjected to tampering. Additionally, it can be noted that the AST is already parsed such that the data recipient 402 need not consume processing resources parsing source code on the data recipient 402, which can cause execution of code to be undertaken more quickly.

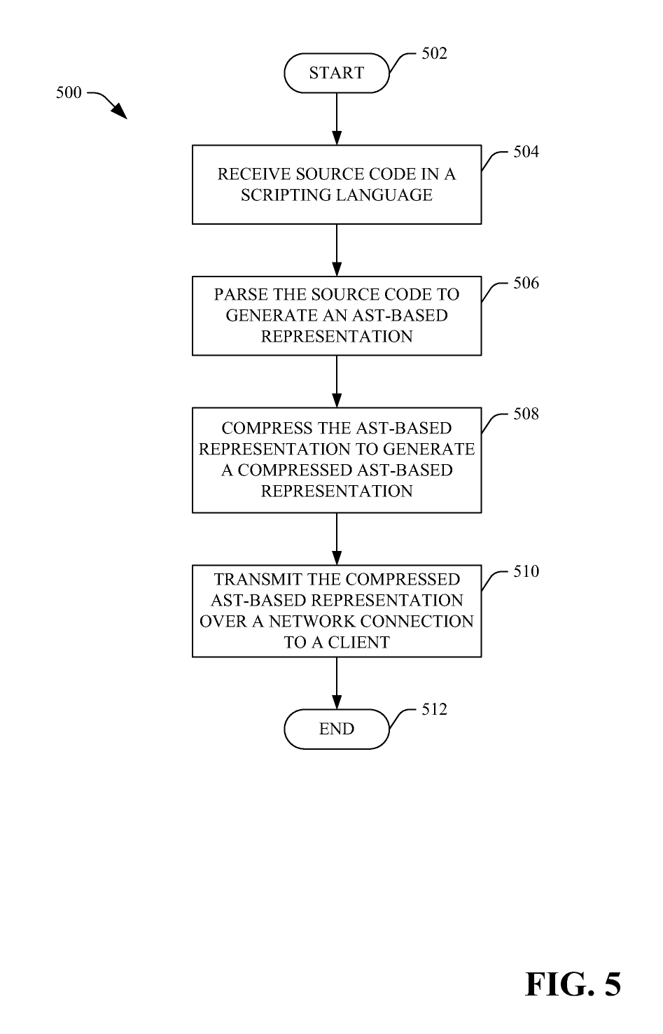

With reference now to FIGS. 5-8, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like.

Referring now to FIG. 5, a methodology 500 that facilitates generating an AST-based representation of source code and compressing such AST-based representation of the source code is illustrated. The methodology 500 begins at 502, and at 504 source code in a scripting language is received. For example, the scripting language may correspond to some particular standard, such as ECMAscript. In a particular example, the source code can be JavaScript®.

At 506, the source code is parsed to generate an AST-based representation of the source code. For example, the source code can be parsed to generate a plurality of different data streams. As indicated above, the plurality of streams may be a tree representation of productions, a stream of identifiers, and a stream of literals.

At 508, the AST-based representation of the source code is compressed to generate a compressed AST-based representation of the source code. For example, a multi-stage compression system may be utilized to compress the AST-based representation of the source code.

At 510, the compressed AST-based representation of the source code is transmitted over a network connection to a client computing device. For example, the compressed AST-based representation can be transmitted upon the user of the client computing device accessing a web page or performing some interaction with such web page. The methodology 500 completes at 512.

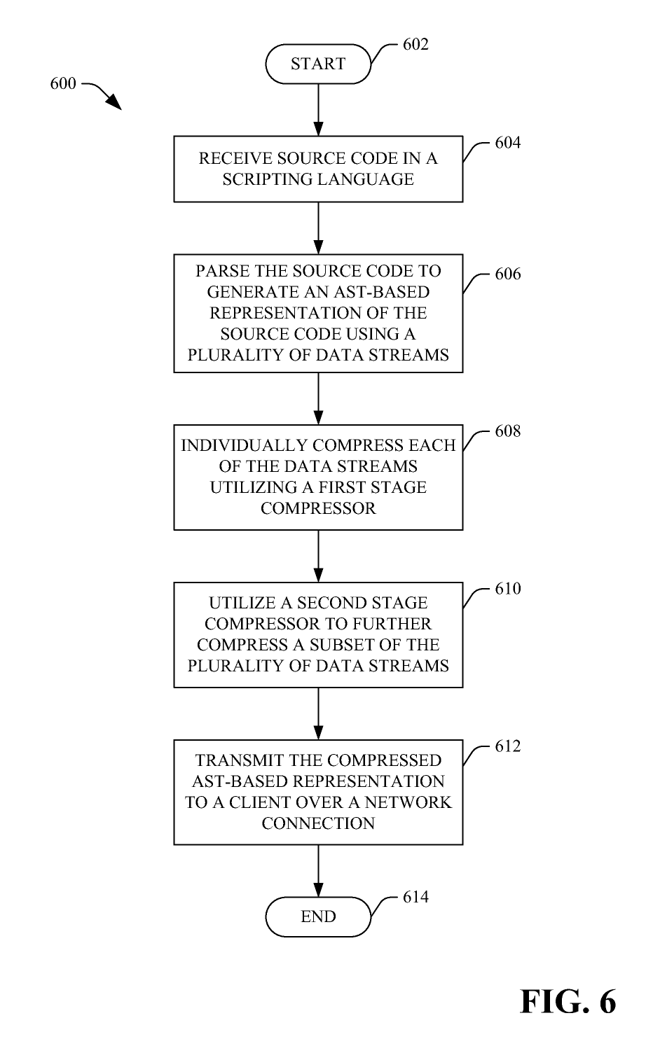

Now referring to FIG. 6, an example methodology 600 that facilitates utilizing a multi-stage compression system to generate a compressed AST-based representation of source code is illustrated. The methodology 600 starts at 602, and at 604 source code is received in a scripting language. At 606, the source code is parsed to generate an AST-based representation of the source code. The source code is parsed, for instance, to generate a plurality of different data streams, wherein at least one of the data streams comprises a tree-based representation of productions corresponding to the source code.

At 608 each of the plurality of data streams is individually compressed, utilizing a first stage compressor. Such individual compression of the data streams has been described above with respect to FIG. 1.

At 610, a second stage compressor is utilized to further compress a subset of the plurality of data streams to generate a compressed AST-based representation of the source code. For example, the second stage compressor may be a gzip compressor that generates a file that is transmittable over a network.

At 612, the compressed AST-based representation output by the second stage compressor is transmitted to a client over a network connection. For instance, the client may be executing a browser thereon, and may desirably receive the compressed AST-based representation of the source code to execute at least one instruction in the browser. The methodology 600 completes at 614.

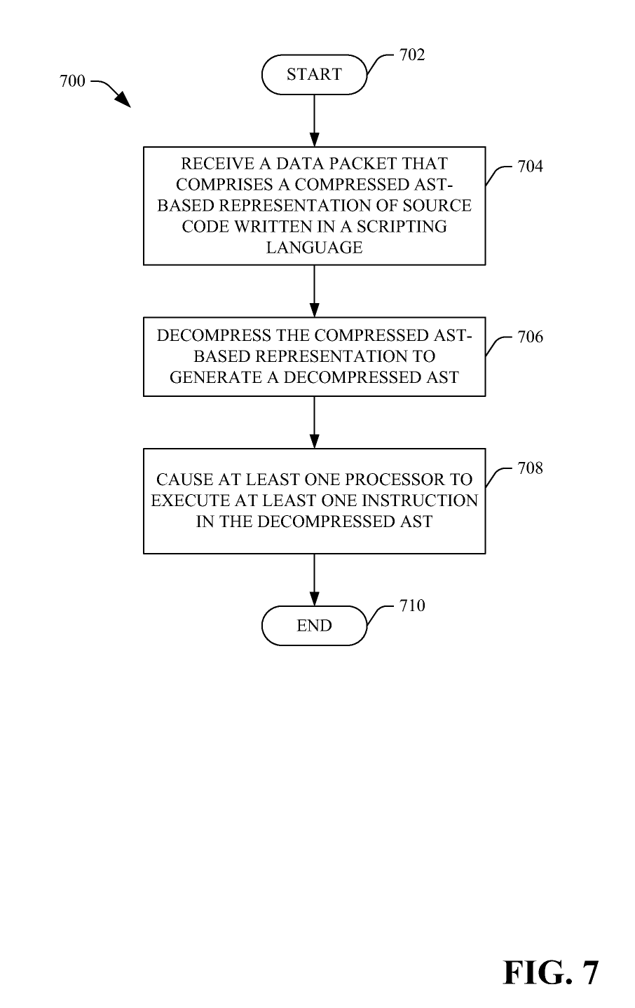

With reference now to FIG. 7, an example methodology 700 for executing at least one instruction through utilization of a compressed AST-based representation of source code is illustrated. For instance, the methodology 700 may be configured to execute on a client computing device such as a personal computer, a mobile phone, etc. The methodology starts at 702, and at 704 a data packet is received over a network connection from an external source, wherein the data packet comprises a compressed AST-based representation of source code that is written in a scripting language.

At 706, the compressed AST-based representation of the source code is decompressed to generate a decompressed AST that represents such source code. At 708 at least one processor on the client computing device is caused to execute at least one instruction represented in the decompressed AST, subsequent to the compressed AST-based representation of the source code being decompressed. The methodology 700 completes at 710.

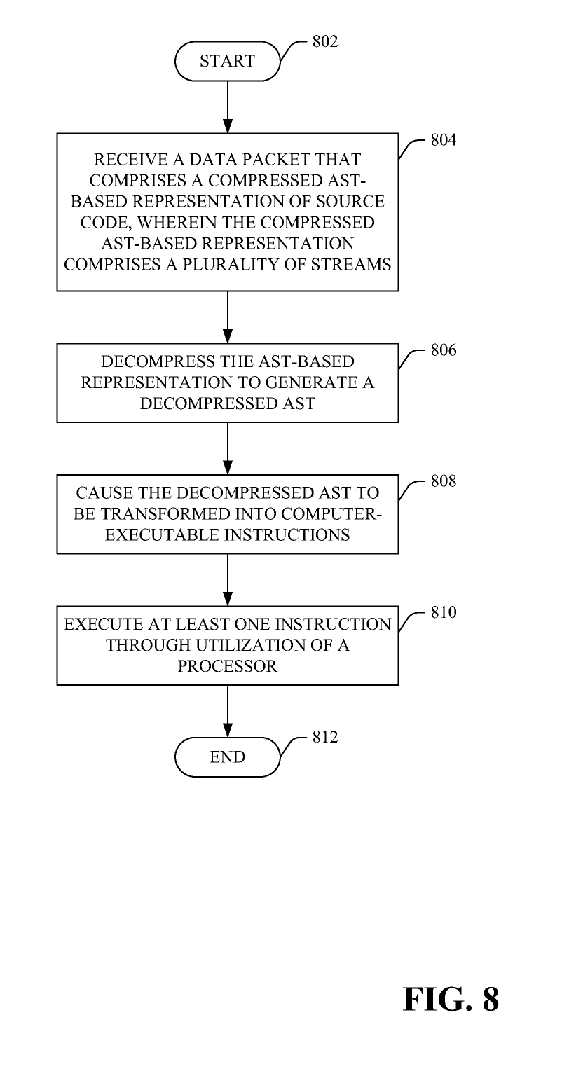

Referring now to FIG. 8, an example methodology 800 that facilitates decompressing an AST-based representation of source code and executing an instruction using the resulting decompressed AST is illustrated. The methodology 800, for instance, can be configured to execute on a client computing device.

The methodology 800 starts at 802, and at 804 a data packet is received, wherein the data packet comprises a compressed AST-based representation of source code. The compressed AST-based representation of the source code may include a plurality of compressed streams, wherein such plurality of compressed streams can comprise a compressed productions stream, a compressed identifiers stream, and a compressed literals stream. Additionally, at least a subset of these streams may be further compressed by a compression algorithm such as gzip.

At 806, the AST-based representation is decompressed, for instance, through utilization of a first decompression algorithm and a second decompression algorithm (a multi-stage decompression technique). Specifically, the first decompression algorithm can be utilized to decompress compression done by the compression model, and the second decompression algorithm can be configured to decompress the AST-based representation of the source code to generate a decompressed AST that is representative of the aforementioned source code.

At 808, the decompressed AST is directly interpreted or compiled to generate machine-executable instructions, and these machine-executable instructions are caused to be stored in memory of a computing device. At 810, at least one of the machine-executable instructions is executed through utilization of at least one processor. The methodology 800 completes at 812.

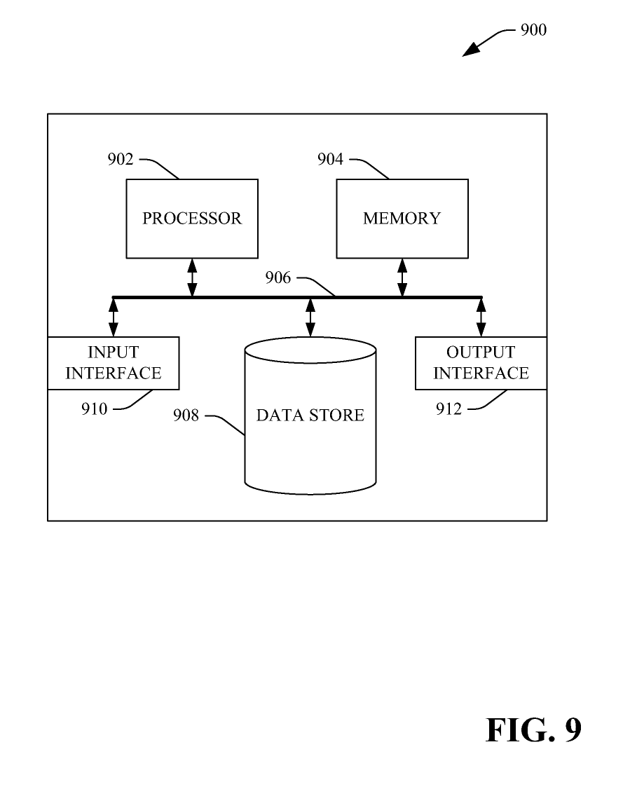

Now referring to FIG. 9, a high-level illustration of an example computing device 900 that can be used in accordance with the systems and methodologies disclosed herein is illustrated. For instance, the computing device 900 may be used in a system that supports compressing source code into an AST-based representation of such source code, and transmitting the compressed AST-based representation of the source code to a client over a network connection. In another example, at least a portion of the computing device 900 may be used in a system that supports receiving a compressed AST-based representation of source code and decompressing such AST-based representation of source code to generate a decompressed AST, and may further be used in a system that supports executing an instruction based upon such AST. The computing device 900 includes at least one processor 902 that executes instructions that are stored in a memory 904. The instructions may be, for instance, instructions for implementing functionality described as being carried out by one or more components discussed above or instructions for implementing one or more of the methods described above. The processor 902 may access the memory 904 by way of a system bus 906. In addition to storing executable instructions, the memory 904 may also store source code, a compressed AST-based representation of source code, an AST or the like.

The computing device 900 additionally includes a data store 908 that is accessible by the processor 902 by way of the system bus 906. The data store 908 may include executable instructions, source code, an AST, a compressed AST-based representation of source code, etc. The computing device 900 also includes an input interface 910 that allows external devices to communicate with the computing device 900. For instance, the input interface 910 may be used to receive instructions from an external computer device, from a user, etc. The computing device 900 also includes an output interface 912 that interfaces the computing device 900 with one or more external devices. For example, the computing device 900 may display text, images, etc. by way of the output interface 912.

Additionally, while illustrated as a single system, it is to be understood that the computing device 900 may be a distributed system. Thus, for instance, several devices may be in communication by way of a network connection and may collectively perform tasks described as being performed by the computing device 900.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Furthermore, as used herein, “computer-readable medium” is intended to refer to a non-transitory medium, such as memory, including RAM, ROM, EEPROM, Flash memory, a hard drive, a disk such as a DVD, CD, or other suitable disk, etc.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method comprising the following computer-executable acts:
at a computing device, receiving, over a network connection, a data packet from an external source, wherein the data packet comprises a compressed abstract syntax tree (AST)-based representation of source code written in a scripting language;
decompressing the compressed AST-based representation of the source code to generate a decompressed AST;
causing at least one processor to execute at least one instruction represented in the decompressed AST subsequent to the compressed AST-based representation of the source code being decompressed.

2. The method of claim 1, wherein the computing device is a mobile telephone.

3. The method of claim 1, wherein the scripting language is JavaScript®.

4. The method of claim 1, wherein at least a portion of the AST is executed by a web browser executing on the computing device.

5. The method of claim 1, wherein decompressing the compressed AST-based representation of the source code comprises:
executing a first decompression algorithm on the compressed AST-based representation of the source code to generate a partially decompressed AST-based representation of the source code; and
executing a second decompression algorithm on the partially compressed AST-based representation of the source code to generate the decompressed AST.

6. The method of claim 5, wherein the partially compressed AST comprises a compressed stream of literals, a compressed stream of identifiers, and a compressed tree-based representation of productions, and wherein executing the second decompression algorithm comprises utilizing a plurality of different decompression techniques to individually decompress each of the compressed stream of literals, the compressed stream of identifiers, and the compressed tree-based representation of productions.

7. The method of claim 6, wherein the second decompression algorithm is configured to decompress the compressed stream of identifiers, wherein the compressed stream of identifiers comprises at least one global table that comprises a list of global symbols and an index corresponding thereto, and wherein the compressed stream of identifiers further comprises at least one local table that comprises a list of local symbols and an index corresponding thereto.

8. The method of claim 6, wherein the second decompression algorithm is configured to decompress the compressed stream of identifiers, wherein the compressed stream of identifiers comprises at least one table that comprises a list of symbols and index values corresponding thereto, wherein the list of symbols is sorted by frequency of occurrence in the portion of the source code.

9. The method of claim 6, wherein the second decompression algorithm is configured to decompress the compressed stream of identifiers, wherein the compressed stream of identifiers comprises a plurality of symbols that are encoded with variable length.

10. The method of claim 6, wherein the second decompression algorithm is configured to decompress the compressed tree-based representation of productions through utilization of prediction by partial match (PPM).

11. The method of claim 10, wherein the compressed tree-based representation of productions is through utilization of an arithmetic coder.

12. The method of claim 6, wherein the compressed stream of literals comprises literals that are separated by type.

13. The method of claim 5, wherein the first decompression algorithm is configured to decompress files that have been compressed by way of a gzip compressor.

14. A system comprising the following computer-executable components:
a receiver component that receives a compressed Abstract Syntax Tree (AST)-based representation of source code written in a scripting language; and
a decompressor component that decompresses the AST-based representation of source code to generate an AST, and wherein the decompressor component causes the AST to be retained in a computer-readable medium for execution by a processor.

15. The system of claim 14 comprised by a browser.

16. The system of claim 14 comprised by a portable computing device.

17. The system of claim 14, wherein the scripting language is JavaScript®.

18. The system of claim 14, wherein the compressed AST-based representation of the source code comprises a plurality of separate streams, wherein each of the plurality of separate streams is decompressed by the decompressor component.

19. The system of claim 18, wherein the plurality of separate streams comprise an identifier stream that comprises data corresponding to identifiers in the source code, a production stream that comprises a tree-based representation of productions in the source code, and a literal stream that comprises literals in the source code.

20. A computer-readable medium comprising instructions that, when executed by a processor, cause the processor to perform acts comprising:
receive a data packet that comprises a compressed Abstract Syntax Tree (AST)-based representation of source code written in a scripting language, wherein the compressed AST-based representation of the source code comprises a plurality of compressed streams, wherein the plurality of compressed streams comprise a compressed identifiers stream, a compressed productions stream, and a compressed literals stream, and wherein the plurality of compressed streams have been further compressed by a compression model;
decompress the compressed AST-based representation of the source code to generate an AST through utilization of a first decompression algorithm and a second decompression algorithm, wherein the first decompression algorithm is utilized to decompress compression undertaken by the compression model and the second decompression algorithm is utilized to further decompress the three compressed streams;
cause the decompressed AST to be placed in memory; and
execute the decompressed AST in the memory.
